(19) United States
(12) Patent Application Publication
(10) Pub. No.: US 2015/0244694 A1
(43) Pub. Date: Aug. 27, 2015

(54) AUTHORIZING SERVER, AUTHORIZING METHOD AND COMPUTER PROGRAM PRODUCT

(71) Applicants: MIXTRAN INC., Hsin Chu (TW); INTER MARKET TRADE/FZE, Ajman (AE)

(72) Inventors: Yvette E-Wen Lin, Hsinchu (TW); Lung-Chiu Chang-Hsu, Hsinchu (TW)

(73) Assignees: INTER MARKET TRADE/FZE, Ajman (AE); MXTRAN INC., Hsin Chu (TW)

(21) Appl. No.: 14/187,410

(22) Filed: Feb. 24, 2014

(51) Int. Cl. H04L 29/06; G06Q 20/40; G06Q 20/10

(52) U.S. Cl. CPC H04L 63/08; H04L 63/0838; H04L 63/0853; G06Q 20/1085; G06Q 20/40

(57) ABSTRACT

The invention relates to an authorizing server, an authorizing method and a computer program product. An authorizing system server is in communication with an electronic device and an agent device. The authorizing server includes a transceiver and a processor. The transceiver receives a request issued by the electronic device. The processor provides an initial authorizing code in response to the request, and generates a server side code accordingly. After transmitting the initial authorizing code, the transceiver receives a remote side code, obtained according to the initial authorizing code. The processor authorizes an operation procedure to be executed when a predetermined condition is satisfied.

### BACKGROUND OF THE INVENTION

1. Field of the Invention

The invention relates in general to an authorizing server, an authorizing method and a computer program product, and more particularly to an authorizing server, an authorizing method and a computer program product, which are used in conjunction with an electronic device.

2. Description of the Related Art

Nowadays, many automation services are attendant on the advancing network. For example, the monetary transaction system is an example of providing convenient services for the users through the network. For the financial institution, the automation services not only saves many operating costs but also brings more rapid and diversified services for the user.

The typical monetary transaction system provides the automatic financial services through the network bank or the automated teller machine (hereinafter, ATM). The ATM card always plays a very important role when the user uses either the network bank or the ATM to execute the automation transaction. The monetary transaction system must verify the user's identification through the use of the ATM card, and thus provides the financial service according to the user's account. In short, when the monetary transaction system provides the automation transaction, the security of identification recognition still has to be noted.

However, this transaction mode has some problems. For example, not every bank customer has the card reader and the transaction function of the network bank, the user does not always carry the ATM card, and the number of ATMs provided by the bank is also limited. In other words, the automation services provided by the conventional monetary transaction system are still not convenient.

As mentioned hereinabove, the monetary transaction system must perform the identification recognition on the depositor so that the user can use the automation service. However, the existing monetary transaction system must perform the identification recognition on the depositor through the ATM card, thereby brings inconvenience to the user.

In addition to the financial system, many authorizing systems also encounter the similar problems. That is, the authorizing systems have to consider the convenience of the user in performing the automation operation as well as the security problem upon performing the authorizing service.

### SUMMARY OF THE INVENTION

The invention is directed to an authorizing server, two authorizing methods and a computer program product, which can satisfy the considerations of the convenience and the security.

According to a first aspect of the present invention, an authorizing server including a transceiver and a processor is provided. The transceiver receives a request. The processor provides an initial authorizing code in response to the request, and generates a server side code according to the initial authorizing code. The transceiver receives a remote side code after transmitting the initial authorizing code. The remote side code is obtained according to the initial authorizing code. An operation procedure is authorized to be executed when a predetermined condition is satisfied.

According to a second aspect of the present invention, an authorizing method applied to an authorizing server is provided. The authorizing method includes following steps. An initial authorizing code is provided in response to a request. A server side code is generated according to the initial authorizing code. A remote side code is received, wherein the remote side code is obtained according to the initial authorizing code. An operation procedure is authorized to be executed when the remote side code and the server side code match with a predetermined condition.

According to a third aspect of the present invention, an authorizing method applied to an electronic device is provided. The authorizing method includes following steps. A request is transmitted. An initial authorizing code generated in response to the request is received. A remote side code is generated according to the initial authorizing code. The remote side code is transmitted to an authorizing server through an agent device. The authorizing server authorizes an operation procedure to be executed according to the remote side code when a predetermined condition is satisfied.

According to a fourth aspect of the present invention, a computer program product storing a software program is provided. The software program upon executing enables an electronic device having a controller to perform an authorizing method. The authorizing method includes following steps. Firstly, a request is transmitted. An initial authorizing code is received, wherein the initial authorizing code is generated in response to the request. Then, a remote side code is generated according to the initial authorizing code and transmitted to an authorizing server through an agent device. The authorizing server authorizes an operation procedure to be executed according to the remote side code when a predetermined condition is satisfied.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram showing an authorizing system according to a first embodiment of the invention;

FIGS. 2A and 2B are schematic diagrams showing the authorizing system according to the first embodiment of the invention;

FIG. 3 is a schematic diagram showing options of mobile bank function provided by an electronic device;

FIG. 4A is a schematic diagram showing that a user utilizes the electronic device to select a withdrawal account;

FIG. 4B is a schematic diagram showing that the user utilizes the electronic device to input the withdrawal amount;

FIG. 5 is a schematic diagram showing that an authorizing server transmits an initial authorizing code to the electronic device through a short message;

FIG. 6 is a schematic diagram showing that the electronic device provides an option of cardless withdrawal function;

FIG. 7A is a schematic diagram showing that the user selects to obtain a remote side code;

FIG. 7B is a schematic diagram showing that the user inputs the initial authorizing code;

FIG. 7C is a schematic diagram showing that the electronic device displays the remote side code;

FIG. 8A is a schematic diagram showing that the user inputs the initial authorizing code through an ATM;

FIG. 8B is a schematic diagram showing that the user inputs the remote side code through the ATM;

FIG. 9 is a schematic diagram showing that a smart film is utilized in a mobile phone;

FIG. 10 is a schematic diagram showing an authorizing system according to a second embodiment of the invention;

FIG. 11 is a schematic diagram showing an authorizing system of the invention; and

FIGS. 12A and 12B are schematic diagrams showing a flow chart of an authorizing method of the invention.

### DETAILED DESCRIPTION OF THE INVENTION

For the sake of illustration, a monetary transaction system serves as an example of the authorizing system in the following. In the following description, the user can utilize an electronic device to perform a withdrawal procedure without an ATM card. However, the authorizing method of the invention may also be widely applied to other types of monetary transaction procedures and various types of authorizing systems. As mentioned hereinabove, the authorizing system must consider both the security and convenience. Thus, the authorizing server of the invention enables the user to use a portable electronic device (e.g., mobile phone) to verify the user's identification more conveniently and quickly. In addition, the invention compares a server and a remote side codes which are generated by the authorizing server and the electronic device respectively. Consequently, the security of the authorizing system can be maintained.

According to the first embodiment of the invention, the user can use the automated teller machine (hereinafter, ATM) together with the mobile phone to perform the withdrawal procedure. In this embodiment, the monetary transaction system (an authorizing system) includes an ATM (an agent device) and a financial platform (an authorizing server). The monetary transaction system verifies the users identification and access authority through the users mobile phone (an electronic device). The authorizing method of the invention can verify the user's identification in a more convenient manner.

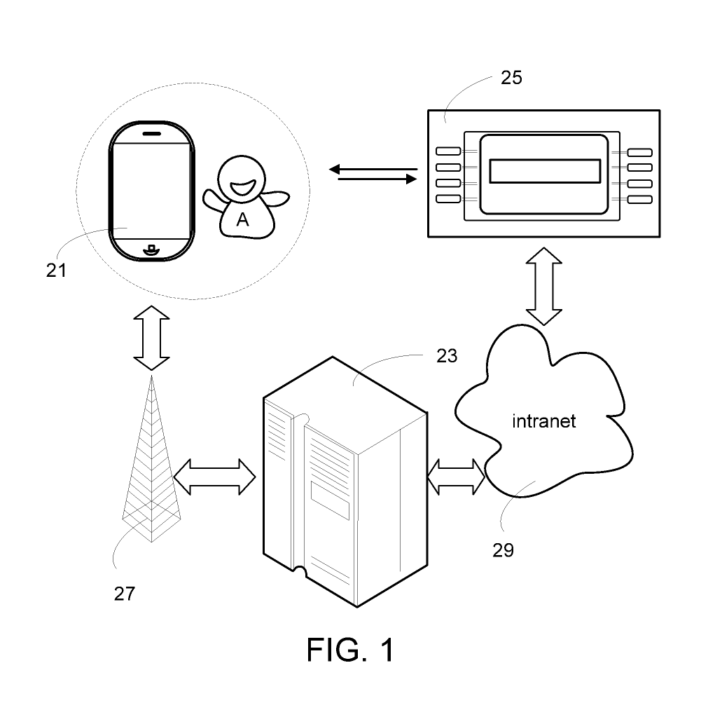

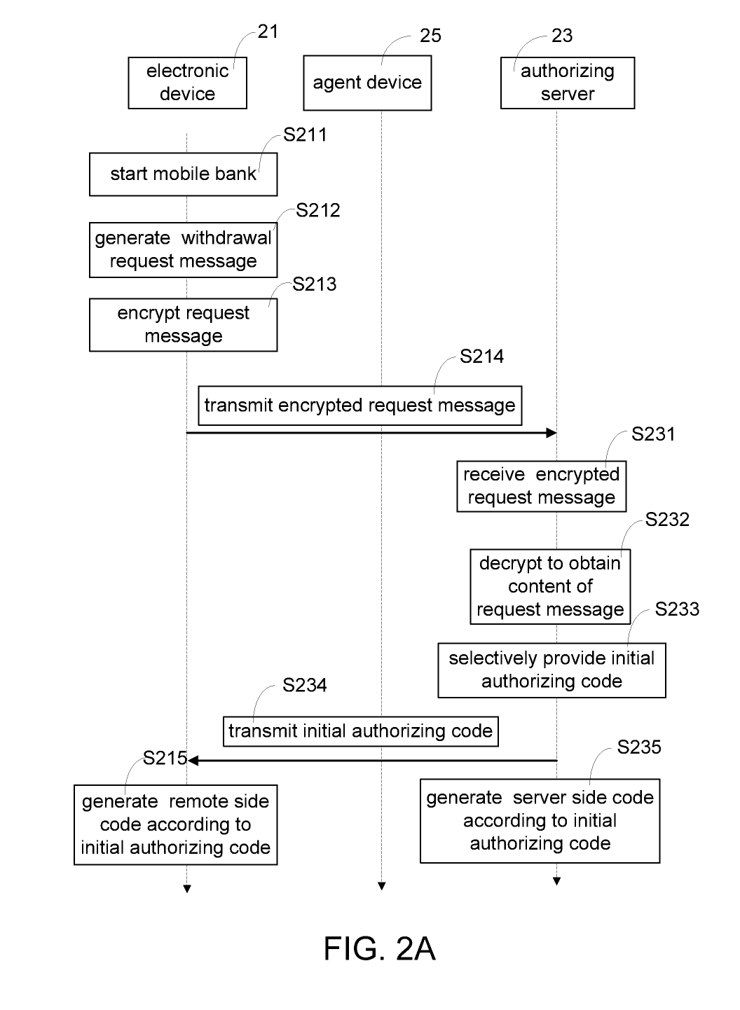

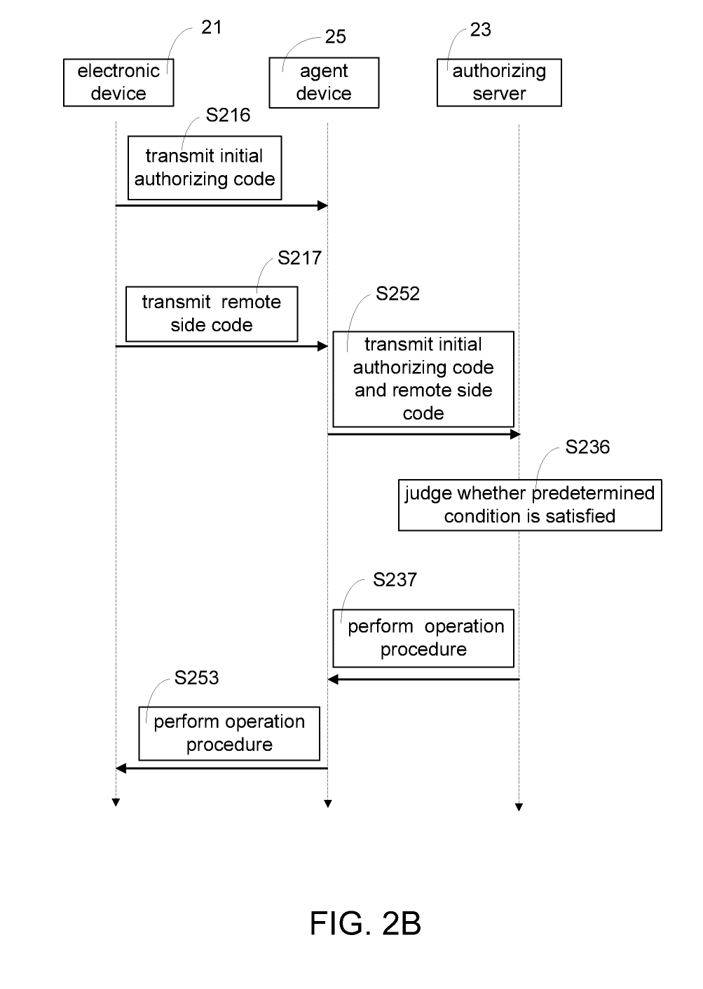

FIG. 1 is a schematic diagram showing an authorizing system according to a first embodiment of the invention. Referring to FIG. 1, an electronic device 21 is in communication with an authorizing server 23 through a telecommunication network. The authorizing server 23 is in communication with an agent device 25 through an intranet 29. The electronic device 21 may be in communication with the agent device 25 by way of short-distance transmission technology. Alternatively, the user holding the electronic device 21 may manually operate the input interface of the agent device 25. Detail steps performed between the authorizing system and the electronic device may be found in the descriptions of FIGS. 2A and 2B.

FIGS. 2A and 2B are schematic diagrams showing the authorizing system according to the first embodiment of the invention. In FIGS. 2A and 2B, three vertical axes represent the actions of the electronic device 21, the agent device 25 and the authorizing server 23 along the time axes. If the executed action relates to two devices, an arrow direction is depicted.

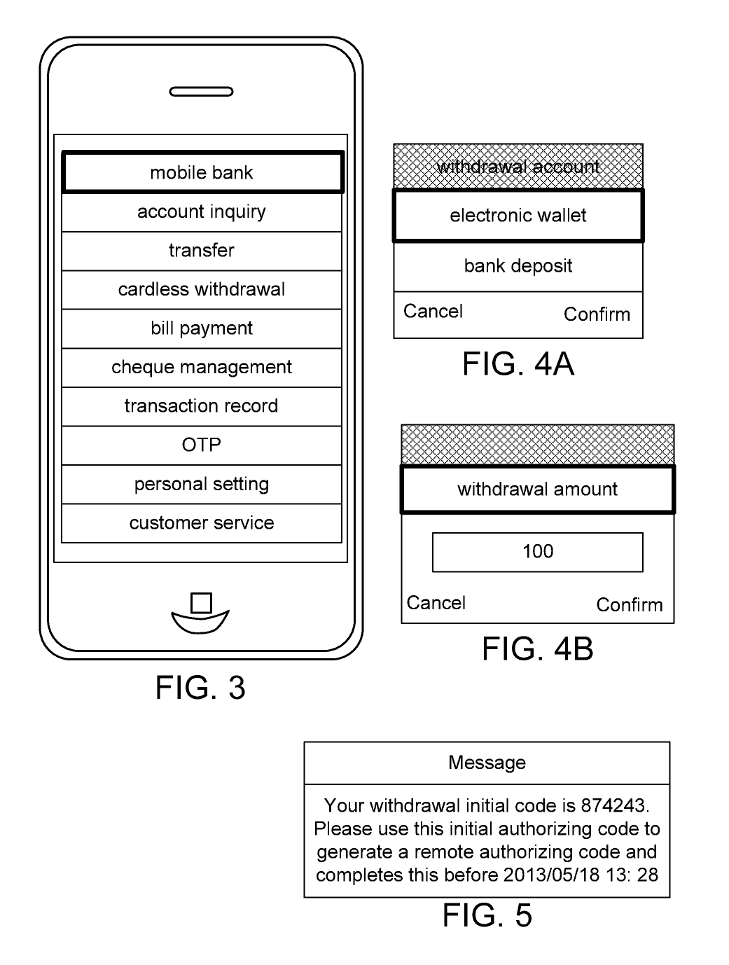

For the sake of illustration, the processes of FIGS. 2A and 2B will be described based on the architecture of FIG. 1. In addition, the processes will be described in conjunction with the executed pages of the electronic device 21 and the agent device 25 with reference to FIGS. 3, 4A, 4B, 5, 6, 7A, 7B, 7C, 8A and 8B.

First, the user selects a mobile bank function (step S211, FIG. 3) through the application software. Next, FIG. 4A represents that the user selects to perform the withdrawal from the electronic wallet. FIG. 4B assumes that the withdrawal amount inputted by the user is 100 dollars. Herein, these operations to be performed by the user are further converted into a request. The request may be transformed to a request message for transmission. The request message represents the transaction content and details proposed by the user. For example, the user A selects to withdraw 100 dollars from his/her electronic wallet. The electronic device 21 correspondingly generates and issues a withdrawal request message according to the user's operation (step S212). Based on the security consideration, the electronic device 21 can encrypt the request message (step S213), and then transmit the encrypted request message to the authorizing server 23 (step S214) through a telecommunication network 27.

After receiving the encrypted request message (step S231), the authorizing server 23 decrypts the encrypted request message and obtains the transaction content and details contained in the request message (step S232). For example, the authorizing server 23 decrypts the encrypted request message, and then judges that the request message is issued by the user A, and the user A hopes to withdraw 100 dollars.

Next, the authorizing server 23 verifies whether the account of the user A exists and judges whether the account balance of the user A is sufficient to pay the withdrawal amount of this withdrawal transaction. That is, the authorizing server 23 judges whether the account of the user transmitting the request message exists in the authorizing database. In addition, the authorizing server 23 judges whether the content of the request message matches with an access authority corresponding to the user account.

If the authorizing server 23 judges that the user account does not exist, or the operation to be performed by the user is beyond the user's access authority although the user account exists, the authorizing server 23 can transmit an error prompt message to the mobile phone of the user A through a short message service (hereinafter, SMS). In response to this situation, the authorizing process can be directly terminated. If the authorizing server 23 judges that the user account exists and that the operation to be performed by the user matches with the user authority, then the authorizing server 23 generates an initial authorizing code. Thus, in the step S233, the authorizing server 23 selectively provides the initial authorizing code.

The initial authorizing code generated by the authorizing server 23 may be transmitted to the electronic device 21 through the SMS (step S234). Based on the security consideration, when the authorizing server 23 transmits the initial authorizing code, a predetermined period is further restricted. After receiving the initial authorizing code, the user must complete the subsequent authorizing process within the predetermined period. That is, the user must use the agent device 25 to transmit a remote side code to the authorizing server 23 within the predetermined period. The remote side code is generated by the electronic device 21 after the electronic device receives the initial authorizing code. The exact duration of the predetermined period needs not to be restricted and may be assumed to be 5 minutes, 30 minutes or the like.

For example, FIG. 5 represents that the authorizing server informs the initial authorizing code of 874243 to the user through the SMS. In addition, the user is also informed to utilize the electronic device 21 to generate the remote side code and complete the transmission of the remote side code before the time of 13:28, 05-18-2013.

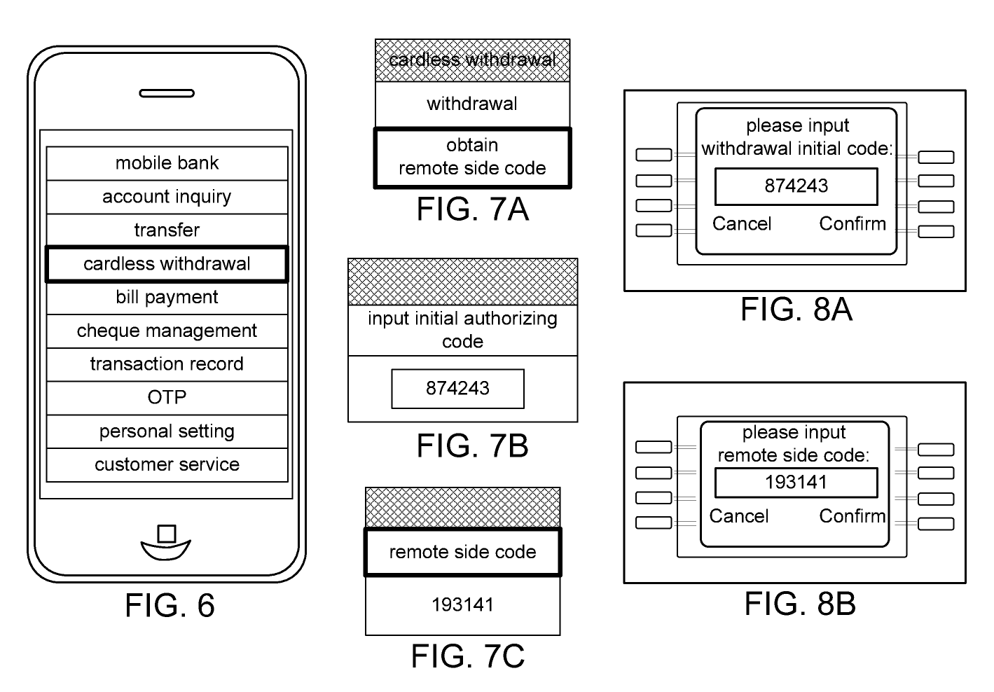

As shown in FIG. 6, it is assumed that the user selects to perform the cardless withdrawal after receiving the SMS. At this time, the electronic device 21 performs a one time password (hereinafter, OTP) generating procedure based on the initial authorizing code, and thus generates the remote side code (step S215). FIG. 7A represents the function that the user selects to obtain the remote side code. FIG. 7B shows that the user inputs the initial authorizing code of 874243 after the electronic device 21 displays the frame of inputting the initial authorizing code. FIG. 7C shows the remote side code of 193141 generated by the electronic device 21 after performing the OTP generating procedure according to the initial authorizing code of 874243.

In the practical application, each step of the process may also be implemented using different methods. For example, the SMS is only a transmission medium for the authorizing server 23 to transmit the message such as the error prompt code, the initial authorizing code or the like, to the electronic device 21. However, other types of transmission methods, such as on the air (OTA), real-time communication software (e.g., WhatsApp, Line etc.), electronic mail, and the like, may serve as the media for transmitting the messages.

Furthermore, the OTP generating procedure provided by the electronic device 21 can be automatically executed through the application software after the initial authorizing code is received. Alternatively, the electronic device 21 may provide an operation page for the user to manually input the initial authorizing code, and further generate the remote side code after “Confirm” is selected. It is to be noted that the implementation and the storage medium of the application software need not to be restricted, and may be modified by those skilled in the art.

After the mobile phone generates the remote side code, the user inputs the initial authorizing code and the remote side code to the agent device (steps S216, S217). FIG. 8A shows the prompt message displayed on the screen of the ATM for the user to manually input the initial authorizing code through the input interface, such as physical keys, the touch screen or the like. After the user has inputted 874243 and pressed down “Confirm”, the screen of the ATM displays the prompt frame of FIG. 8B. The user again manually inputs the remote side code to the ATM by referring to the screen of the mobile phone.

In addition to the manually input method, the short-distance transmission technology may also be adopted to perform the transmitting and receiving of the initial authorizing code and the remote side code between the mobile phone and the ATM. The short-distance transmission technology may be the wireless network, near field communication (NFC) and the like.

The ATM transmits the initial authorizing code and the remote side code to the authorizing server (step S252) after receiving the initial authorizing code and the remote side code. The authorizing server 23 further judges whether the predetermined condition is satisfied (step S236).

The predetermined condition further includes two judgments. The first judgment is to judge whether the period of generating the initial authorizing code and receiving the remote side code is shorter than the predetermined period. The second judgment is to judge whether the server side code generated by the authorizing server itself matches with the received remote side code. When both the two judgment results are affirmative, the predetermined condition is regarded as satisfied. When the first judgment result is negative, it represents that the authorizing server 23 receives the remote side code too late. At this time, the authorizing server 23 interrupts the user's withdrawal procedure to prevent the initial authorizing code from running off. Furthermore, the second judgment is used to further ensure the security of the withdrawal procedure.

In order to enhance the security of data transmission, the authorizing server 23 and the electronic device 21 respectively compute the initial authorizing code according to the OTP generating procedure to generate the server side code and the remote side code. The OTP generating procedure dynamically generates the password, and the correspondingly calculation result is unpredictable. Because the authorizing server 23 and the electronic device 21 individually perform the OTP generating procedure according to the same initial authorizing code, the server side code and the remote side code should be consistent with each other. If the server side code generated by the authorizing server 23 is not consistent with the received remote side code, the remote side code may be interfered upon transmission, and the authorizing process will be interrupted for security.

Only when the predetermined condition is judged as satisfied, the authorizing server 23 approves the withdrawal procedure proposed by the user. Thereafter, the authorizing server 23 authorizes the agent device 25 to perform the operation procedure (step S237), and the agent device 25 provides the operation procedure required by the electronic device 21 (step S253). The operation procedure is the service content (e.g., the provision of the cash of 100 dollars) provided in response to the request message generated by the electronic device 21.

Moreover, if the user hopes to perform multiple sets of monetary transactions, the similar process is repeatedly performed. If the user hopes to perform three monetary transactions, then the electronic device 21 issues three corresponding request messages according to the three monetary transactions. The authorizing server 23 provides three separate initial authorizing codes according to the three request messages. The authorizing server 23 performs the OTP generating procedure according to the three separate initial authorizing codes and thus generates three separate server side codes; and the electronic device 21 generates three separate remote side codes as well. After receiving the three remote side codes through the agent device 25, the authorizing server 23 respectively judges whether the predetermined condition corresponding to each of the received three remote side codes is satisfied.

Because the three monetary transactions have the corresponding initial authorizing codes, the authorizing server 23 still can obviously distinguish between the three monetary transactions even if the time instants of generating the three monetary transactions are relatively close to one another. Furthermore, because the three monetary transactions are independent from one another, various conditions, in which only one monetary transaction smoothly passes the authorizing process, all the three monetary transactions pass the authorizing process, none of the three monetary transactions pass the authorizing, and the like, may occur.

In the practical application, the application software (e.g., mobile bank) used by the electronic device 21 may run on a typical embedded operation system (e.g., Android). Alternatively, the application software may also be provided by the component in the relative lower layer of the electronic device. For example, the application software is stored in the SIM card or a Micro SIM card. In addition, the application software may also be provided through a smart film 83, which is an ultra-thin circuit having the size equal to the SIM card, and can provide the application software for the authorizing process.

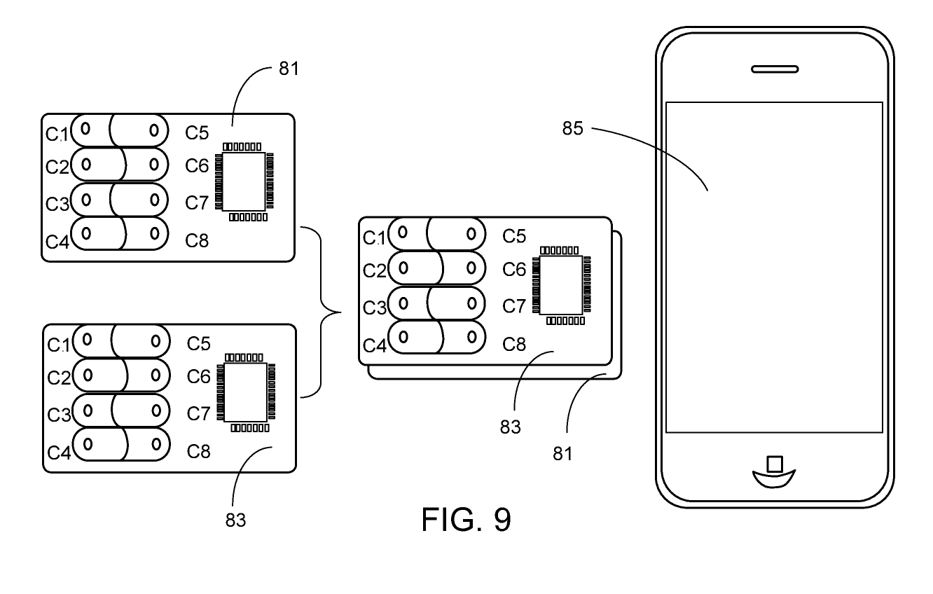

FIG. 9 is a schematic diagram showing that a smart film is utilized in conjunction with a mobile phone. In terms of appearance, the smart film 83 is a thin sheet. The layout of connection points on the surface of the smart film is consistent with that of the connection points of the SIM card 81.

In addition, the connection points C1 to C8 of the smart film 83 can conduct the top side of the smart film to the bottom side of the smart film. The smart film 83 is attached to the connection points between the SIM card and the socket and is compatible with the circuit of the SIM card.

Those skilled in the art know that the mobile phone 85 must work in conjunction with the SIM card 81 so that various telecommunication services can be provided. Thus, all the mobile phones 85 have the SIM card sockets. When the mobile bank function is provided through the smart film 83, it is unnecessary to consider the telecommunication provider, the type of the communication device nor the type of the SIM card. Thus, the smart film 83 is a very convenient media of implementation.

Furthermore, the second embodiment of the invention is proposed for the areas, in which the ATMs are not popularized. In these areas, the financial institution may establish cooperation relationship with persons or other providers (hereinafter referred to as an agent). When the ordinary person hopes to perform the monetary transaction, he or she can seek for the help of these agents.

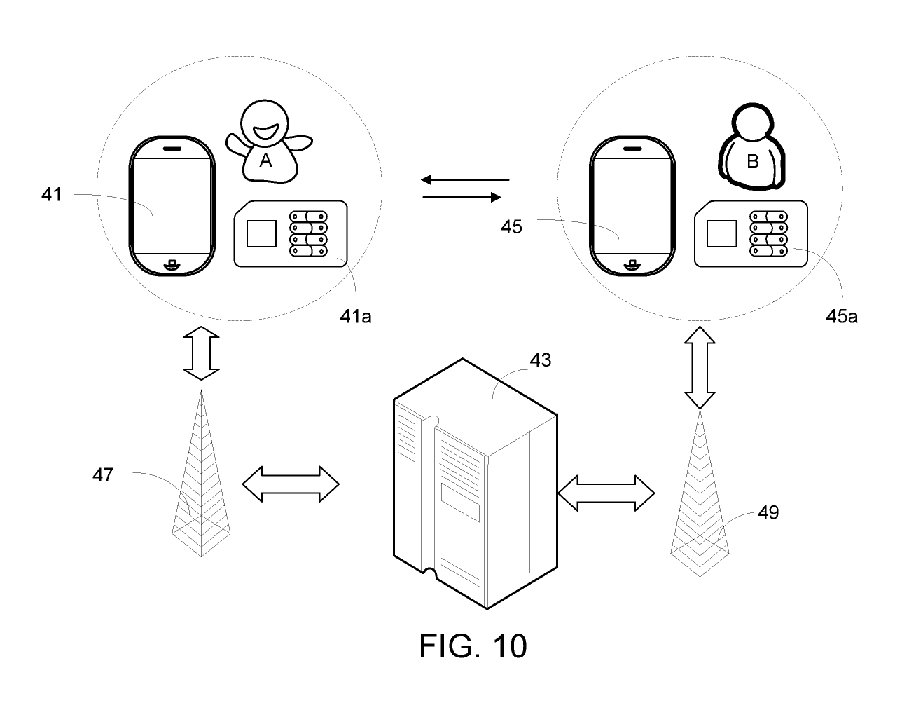

FIG. 10 is a schematic diagram showing an authorizing system according to a second embodiment of the invention. As shown in FIG. 10, it is still assumed that the user only has the mobile phone (first mobile phone 41) but has no ATM card. On the other hand, it is assumed that the agent provides the agent apparatus (second mobile phone 45). In this case, the second mobile phone 45 plays the role of the agent device.

The second mobile phone 45 can provide an input interface through a touch panel or keys. The user or agent can perform the input operation through the input interface. Thus, the second mobile phone 45 can obtain the initial authorizing code and the remote side code. In addition, the second mobile phone further includes a transmitting module for transmitting the initial authorizing code and the remote side code to the authorizing server 43.

Similarly, in this embodiment, the second mobile phone 45 (the agent device) may also participate in the authorizing process using the application software built in the smart film through a second SIM card. Of course, the application software adopted by the second mobile phone 45 to participate in the authorizing process may also run in the embedded OS built in the second mobile phone 45. Alternatively, the application software may be provide by bottom layer software of the second SIM card. The method of this portion may be analogized according to the descriptions mentioned hereinabove, and detailed descriptions thereof will be omitted.

In this embodiment, the first mobile phone 41 has a first smart film 41a, and the first mobile phone 41 is in communication with the authorizing server 43 through a telecommunication network 47. The second mobile phone 45 has a second smart film 45a, and the second mobile phone 45 is in communication with the authorizing server 43 through a telecommunication network 49. In this embodiment, the interactions between the first mobile phone 41, the second mobile phone 45 and the authorizing server 43 are substantially similar to those of the first embodiment, and detailed descriptions thereof will be omitted.

In the second embodiment, however, the user may further orally tell the agent to input the initial authorizing code and the remote side code on the second mobile phone 45. Thereafter, the second mobile phone 45 further transmits the initial authorizing code and the remote side code to the authorizing server 43. Compared with the first embodiment, the second mobile phone 45 obtains the initial authorizing code and the remote side code more flexibly in the second embodiment.

In this embodiment, when the authorizing server 43 judges that the predetermined condition is satisfied, the authorizing server 43 can transmit a short message to the second mobile phone 45 to inform the agent to perform the service content requested by the user. In addition, the authorizing server 43 may also transmit a short message to the first mobile phone 41 at the same time to inform the user that the transaction content has been authorized. Because the user also receives the short message, it is possible to prevent the agent from making mistakes upon performing the financial service on behalf of the first mobile phone.

In this embodiment, the mobile phones of the user and the service provider use the existing telecommunication network. More particularly, the user can finish many monetary transactions without rushing about the financial institutions or finding the ATM. For the financial institution, the cost of installing the ATM can be saved, and the agent can perform the service contents of monetary transactions (e.g. collections and payment transfers) for the financial institutions.

Incidentally, the data exchange between the second mobile phone 45 and the authorizing server 43 is not performed through the intranet in the second embodiment. Thus, the method of the second mobile phone 45 of transmitting the initial authorizing code and the remote side code to the authorizing server 43 and the method of the authorizing server 43 of informing the agent are not restricted to the SMS. For example, other types of transmission methods, such as on the air (OTA), real-time communication software (e.g., WhatsApp, Line or the like), electronic mail or the like may also be adopted.

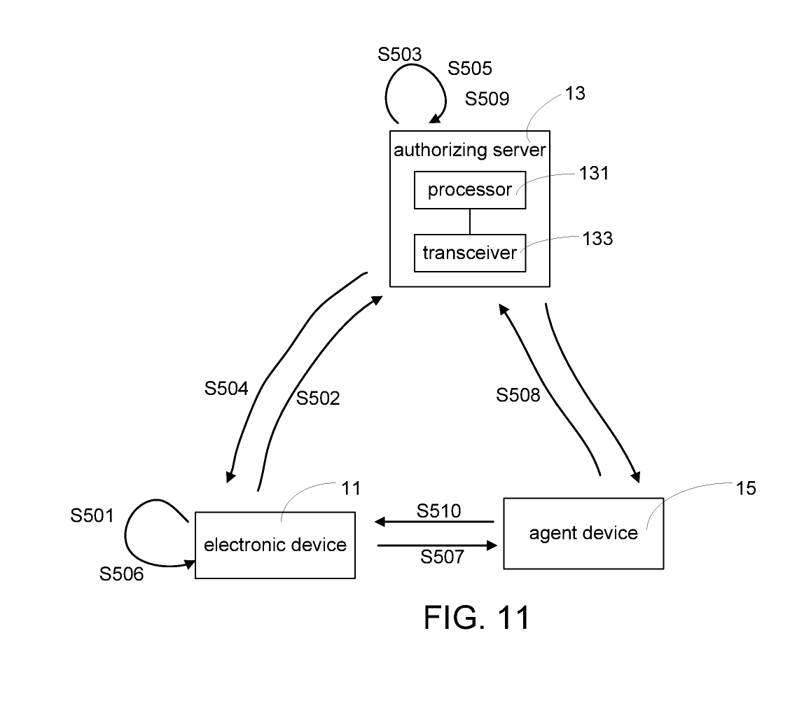

FIG. 11 is a schematic diagram showing the authorizing system of the invention. Referring to FIG. 11 of the invention, the authorizing server 13 is in communication with the electronic device 11 and the agent device 15. The authorizing server 13 includes a processor 131 and a transceiver 133. The transceiver 133 is in communication with the electronic device 11 and the agent device 15.

The transceiver 133 receives a request message transmitted from the electronic device 11. The processor 131 provides an initial authorizing code in response to the request message, and generates the server side code according to the initial authorizing code. After transmitting the initial authorizing code, the transceiver 133 receives a remote side code, which is generated according to the initial authorizing code. Thereafter, the processor 131 authorizes the agent device 15 to execute the operation procedure upon judging that the predetermined condition is satisfied. It is to be noted that although the electronic devices 11 of the two embodiments are the mobile phones, other types of electronic devices 11 may also be used correspondingly.

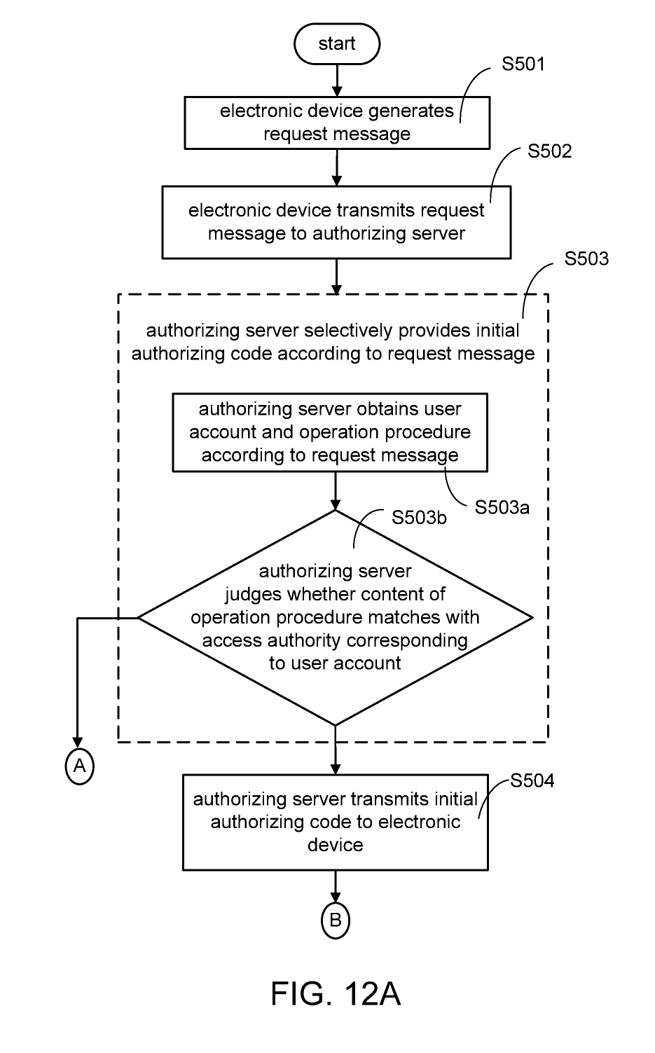

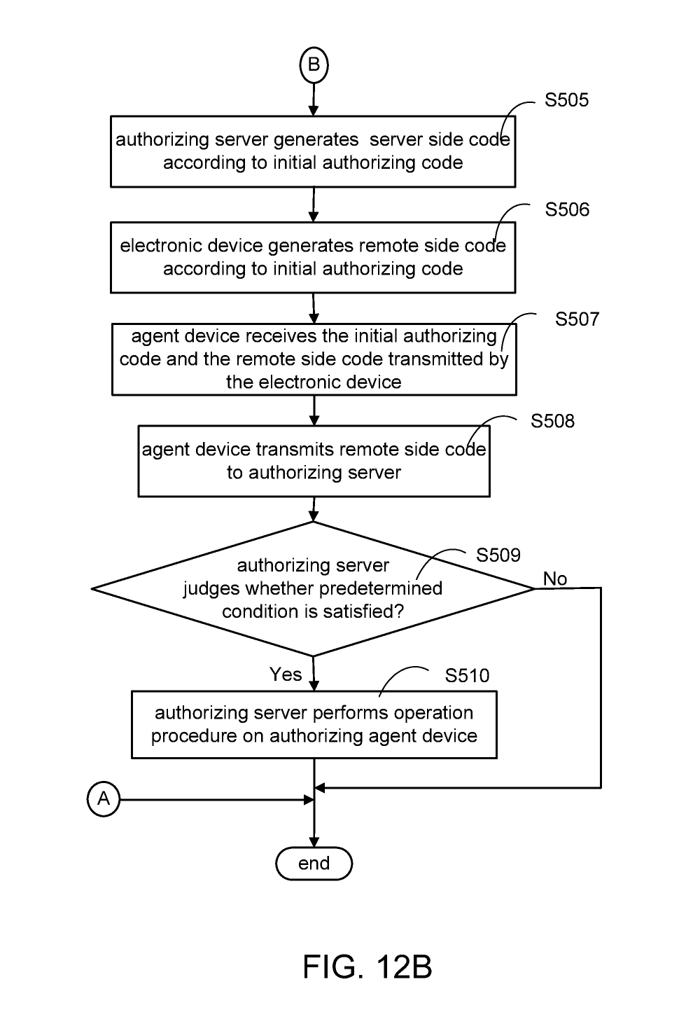

In FIG. 11, the authorizing server 13 is in communication with the electronic device 11 through the telecommunication network (not shown). According to different applications, the agent device 15 may be in communication with the authorizing server 13 through the telecommunication network (not shown) or the intranet (not shown). According to the above embodiments, the serial numbers of the steps in FIG. 11 represent the order of the actions between the agent device 15, the authorizing server 13 and the electronic device 11, and the arrow direction represents the interaction between the devices. The arrows and the corresponding steps in this drawing will be described with reference to FIGS. 12A and 12B.

FIGS. 12A and 12B are schematic diagrams showing a flow chart of an authorizing method of the invention. First, the electronic device 11 generates the request message (step S501), and transmits the request message to the authorizing server (step S502). The authorizing server 13 selectively provides the initial authorizing code according to the request message (step S503).

The step S503 may further include two sub-steps: the authorizing server 13 utilizes the processor 131 to obtain the user account and the operation procedure according to the request message (step S503a); and the processor 131 judges whether the content of the operation procedure matches with the access authority corresponding to the user account (S503b). If the user account obtained in the step S503a does not exist in the database of the authorizing server 13, the authorizing server 13 does not provide the initial authorizing code. In some cases, if the step S503b judges that the content of the operation procedure to be performed by the user does not match with the access authority corresponding to the user account, the authorizing server 13 does not provide the initial authorizing code.

Thereafter, the authorizing server 13 utilizes the transceiver 133 to transmit the initial authorizing code to the electronic device 11 (S504). The processor 131 of the authorizing server 13 generates the server side code according to the initial authorizing code (step S505), and the electronic device 11 generates the remote side code according to the initial authorizing code (step S506). The order of the steps S505 and S506 is not particularly restricted. Alternatively, the steps S505 and S506 may be performed concurrently.

After generating the remote side code, the electronic device 11 transmits the initial authorizing code and the remote side code to the agent device 15 (step S507). Thereafter, the agent device 15 transmits the remote side code to the authorizing server 13 (step S508). The authorizing server 13 judges whether the predetermined condition is satisfied (step S509).

If the judgment result of the step S509 is negative, the authorizing server 13 terminates this authorizing process. At this time, the authorizing server 13 may display an error message through the agent device 15. If the judgment result of the step S509 is affirmative, then the authorizing server 13 authorizes the agent device 15 to proceed and execute the operation procedure (step S510).

Although the embodiment assumes that the electronic device is the mobile phone, the invention is not restricted to the mobile phone upon the practical application. In addition, the authorizing method executed in the electronic device may be implemented through the SIM card, the smart film, the application software or the like. As mentioned hereinabove, the authorizing method of the invention can be stored in various types of computer program products in the form of software programs. Any electronic device having a controller can use the controller to execute the software program implementing the authorizing method of the invention. That is, the software program performs the steps of transmitting the request message; receiving the initial authorizing code generated in response to the request message; generating the remote side code according to the initial authorizing code; and transmitting the remote side code to the authorizing server through the agent device. The authorizing server authorizes execution of the operation procedure when judging that the predetermined condition is satisfied according to the remote side code.

When the authorizing method of the invention is adopted, it is only necessary to verify the users identification in conjunction with the electronic device, and thus to use various automatic monetary transactions. More particularly, the cash can be directly withdrawn in conjunction with the ATM without the ATM card. This authorizing method can eliminate the inconvenience caused when the user needs to carry the ATM card to execute the monetary transaction, and enables the authorizing agent of the financial institution to provide the monetary transaction in the area where the ATMs are not popular. Furthermore, the invention working in conjunction with the OTP generating procedure can also secure the monetary transaction system by verifying the user account.

It is to be noted that even though the above-mentioned description is based on the example of the monetary transaction system, the application of the authorizing system of the invention is not restricted thereto. Any authorizing system, such as the file download system, the goods sales system, the ticket selling system or the like, which needs to perform the user identification recognition can adopt the idea of the invention.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An authorizing server, comprising:
a transceiver, for receiving a request; and
a processor, for providing an initial authorizing code in response to the request, and generating a server side code according to the initial authorizing code, wherein the transceiver receives a remote side code after transmitting the initial authorizing code, wherein the remote side code is obtained according to the initial authorizing code, and an operation procedure is authorized to be executed when a predetermined condition is satisfied.

2. The authorizing server according to claim 1, wherein the predetermined condition represents that the authorizing server receives the remote side code within a predetermined period, and the remote side code matches with the server side code.

3. The authorizing server according to claim 1, wherein the transceiver is in communication with an electronic device, and the electronic device issues the request and generates the remote side code according to the initial authorizing code.

4. The authorizing server according to claim 3, wherein the electronic device is in communication with the transceiver through a telecommunication network.

5. The authorizing server according to claim 3, wherein the processor generates the server side code according to a one time password (hereinafter, OTP) generating procedure, and the electronic device generates the remote side code according to the OTP generating procedure.

6. The authorizing server according to claim 3, wherein the electronic device is a first mobile phone, which issues the request and generates the remote side code according to the initial authorizing code through an application software.

7. The authorizing server according to claim 6, wherein the first mobile phone has a first subscriber identity module (hereinafter, SIM) card, and the application software is provided by the first SIM card or a first smart film compatible with the first SIM card.

8. The authorizing server according to claim 6, wherein the first mobile phone has an embedded operation system (hereinafter, OS), and the application software runs on the embedded OS.

9. The authorizing server according to claim 1, wherein the transceiver is in communication with an agent device, and the agent device transmits the remote side code to the authorizing server after obtaining the remote side code.

10. The authorizing server according to claim 9, wherein the agent device is in communication with the transceiver through an intranet or a telecommunication network.

11. The authorizing server according to claim 9, wherein the agent device provides an input interface for inputting the remote side code.

12. The authorizing server according to claim 9, wherein the agent device is in communication with an electronic device through a short-distance transmission technology, and the remote side code is transmitted from the electronic device to the agent device through the short-distance transmission technology.

13. The authorizing server according to claim 12, wherein the short-distance transmission technology is a wireless network or a near field communication (hereinafter, NFC).

14. The authorizing server according to claim 9, wherein the agent device is an automated teller machine (hereinafter, ATM) or an agent apparatus.

15. The authorizing server according to claim 14, wherein the agent apparatus is a second mobile phone, which comprises:
an input interface, for obtaining the initial authorizing code and the remote side code according to an input operation; and
a transmitting module, for transmitting the initial authorizing code and the remote side code to the authorizing server.

16. The authorizing server according to claim 15, wherein the second mobile phone has a second SIM card, and an application software controlling the input interface is provided by the second SIM card or a second smart film compatible with the second SIM card.

17. The authorizing server according to claim 16, wherein the second mobile phone has an embedded OS, and the application software runs on the embedded OS.

18. The authorizing server according to claim 1, wherein the authorizing server is a financial platform, and the request is a monetary transaction procedure.

19. An authorizing method applied to an authorizing server, comprising steps of:
providing an initial authorizing code in response to a request;
generating a server side code according to the initial authorizing code;
receiving a remote side code, obtained according to the initial authorizing code; and
authorizing an operation procedure to be executed when the remote side code and the server side code match with a predetermined condition.

20. The authorizing method according to claim 19, wherein the predetermined condition represents that:
the authorizing server receives the remote side code within a predetermined period; and
the remote side code matches with the server side code.

21. The authorizing method according to claim 19, wherein the step of generating the server side code according to the initial authorizing code represents that:
the authorizing server generates the server side code according to the initial authorizing code and a one time password (hereinafter, OTP) generating procedure.

22. The authorizing method according to claim 19, further comprising a step of:
transmitting the initial authorizing code to an electronic device.

23. The authorizing method according to claim 22, wherein the electronic device issues the remote side code according to the initial authorizing code and an OTP generating procedure.

24. The authorizing method according to claim 22, wherein the authorizing server is in communication with an agent device, which transmits the remote side code to the authorizing server.

25. The authorizing method according to claim 24, wherein the agent device has an input interface, and the agent device obtains the remote side code inputted by a user through the input interface.

26. An authorizing method applied to an electronic device, the authorizing method comprising steps of:
transmitting a request;
receiving an initial authorizing code generated in response to the request; and
issuing a remote side code according to the initial authorizing code,
wherein the remote side code is transmitted to an authorizing server through an agent device, and the authorizing server authorizes an operation procedure to be executed according to the remote side code when a predetermined condition is satisfied.

27. The authorizing method according to claim 26, wherein the step of issuing the remote side code according to the initial authorizing code represents generating the remote side code according to the initial authorizing code and an one time password (hereinafter, OTP) generating procedure.

28. The authorizing method according to claim 26, wherein the agent device obtains the remote side code from the electronic device through a short-distance transmission technology or an input interface.

29. A computer program product storing a software program, the software program upon executing enables an electronic device having a controller to perform an authorizing method, the authorizing method comprising steps of:
transmitting a request;
receiving an initial authorizing code generated in response to the request;
generating a remote side code according to the initial authorizing code; and
transmitting the remote side code to an authorizing server through an agent device, wherein the authorizing server authorizes an operation procedure to be executed according to the remote side code when a predetermined condition is satisfied.

30. The computer program product according to claim 29, wherein the step of generating the remote side code according to the initial authorizing code represents that generating the remote side code according to the initial authorizing code and a one time password generating procedure.
